(19) United States
(12) Patent Application Publication
(10) Pub. No.: US 2003/0051018 A1
(43) Pub. Date: Mar. 13, 2003

(54) Light weight application management system

(76) Inventors: Giri Parthasarathy Prathivadi Bayankara, Cupertino, CA (US); Srivatsa Krishnaswamy, Bangalore (IN); Rangan Devarajan, Bangalore (IN)

Correspondence Address: HEWLETT-PACKARD COMPANY, Intellectual Property Administration, P.O. Box 272400, Fort Collins, CO, 80527-2400, US

(21) Appl. No.: 09/942,432

(22) Filed: Aug. 29, 2001

(51) Int. Cl. G06F 15/173

(52) U.S. Cl. 709/223

(57) ABSTRACT

An application management system comprises a management centre, at least one application and means for transmitting application management data between said management centre and said managed application, said application management data being at least partially XML-based.

### BACKGROUND OF THE INVENTION

The invention relates to a light weight application management system, which enables quick deployment of application management solution.

In the past and also in present, people use enterprise management tools to manage their application or develop a custom build management solution which involves in lot of investment in terms of both money and effort. These days people are looking for quick ways to make application manageable also over the web.

There are many flavours of application such as, Front-End Applications, Middleware Applications and Back-End Applications. Typically Middleware Applications and Back-End Applications process very native management tools in the form of command line interface (CLI) or they expose some Application Program Interfaces (API) which enable application management.

Application management includes life cycle management, configuration management and event management. Most of the enterprise management products provide life cycle management and event management but not configuration management. But unless the configuration is managed, application behaviour becomes very unpredictable.

In an enterprise management system, the management components are provided with an agent software (in the following also referred to as “agent process”) that monitors and accumulates operational data and may detect exceptional events on the respective application or system resource.

The management server computer manages the managed elements using the agent processes and handles notifications from the agent processes.

In this context, a managed element is a unit which gets monitored or managed by a central instance, e.g. a CPU, a memory unit, a swap, a Web server, a data base server, or a network equipment.

For requesting operational data or receiving event notifications from the agent processes, the network management server computer is provided with management software using management protocols such as the Simple Network Management Protocol (SNMP) or the Common Management Information Protocol (CMIP). The management server computer is further adapted to interpret the operational data and event information to effect control of the network operations, in other words the operations performed by the managed elements. Control operations may be without loss of generality starting, stopping, pausing, resuming or shutting down a process or an application running on the managed element or the managed element itself.

The efforts necessary to realize installation and configuration increases with the complexity of the network management platform.

Accordingly, the limitations of the state of the art in particular may be considered in that the configuration of the enterprise management solution is relatively time-consuming, according to which actually providing management solutions in an enterprise is expensive in terms of time and costs.

### SUMMARY OF THE INVENTION

It is thus an object of the present invention to provide an application management framework and a method for managing different applications for which the efforts necessary to installation and configuration are reduced.

According to one aspect of the invention, there is provided a light weight application management system, comprising an application management server computer, at least one managed application being coupled to the server computer, and means for encoding and decoding application management data for transmission between the management server computer and the managed application, the means for encoding and decoding management data being adapted to encode and decode management data at least partially based on a markup language format.

According to a further aspect of the invention, there is provided an application management server, comprising a first means for encoding and decoding management data for transmission to and from at least one managed application being coupled to the server computer, the first means for encoding and decoding network management data being adapted to encode and decode network management data at least partially based on a markup language format.

The invention achieves the effect that efforts to install the desired application and the necessary time to configure the corresponding application are substantially reduced due to the use of the markup language, in particular XML, technology for the network data exchange.

According to the markup language technology, the application management server computer can e.g. receive the request to get desired information about the application being managed from a browser application program, with the communicated information data units being based on the markup language format. Accordingly, the application management system depends only on the corresponding web-server, according to which the time that is needed to configure the application management platform is significantly reduced.

Another advantage of the invention is that after receipt by the application management centre the desired information may be simply passed to a web browser and illustrated by a GUI (Graphic User Interface), which is easy and comfortable to use.

### BRIEF DESCRIPTION OF THE DRAWINGS

FIG. 1 shows an overall architecture of a application management system according to a preferred embodiment of the invention; and

FIG. 2 is a schematic diagram illustrating the management of network data by an agent provided in the network management system of FIG. 1.

### DESCRIPTION OF THE PREFERRED EMBODIMENTS

Preferred embodiments of this invention and modifications thereof will now be described with reference to the accompanying drawings.

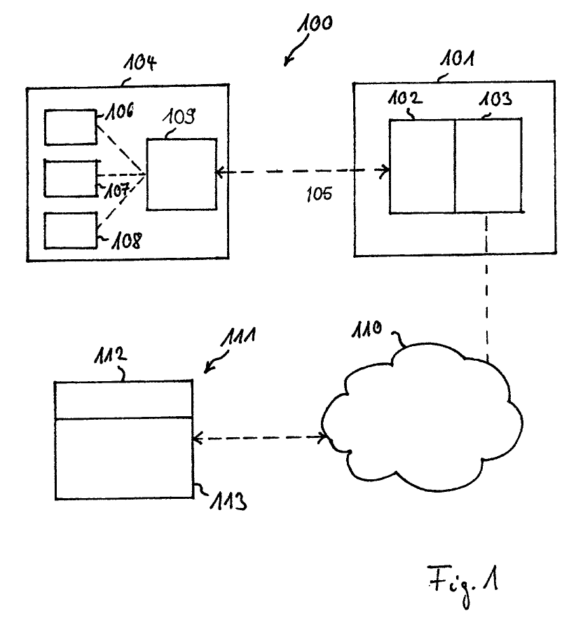

In FIG. 1, an application management system 100 according to the invention is shown in an overall view of the network architecture.

The application management system 100 comprises an application server computer 101, which hosts a TCP- (Transmission Control Protocol-) server 102 and a browser application server program, in other words a web-server program 103.

The application management system 100 further comprises a managed element 104, which is managed by the application management centre 101. In the embodiment shown in FIG. 1, the managed element, also denoted as a managed node 104, is a computer system representing a “client computer” of the application management system 100.

Of course, the application management system 100 according to the invention may comprise a plurality of managed nodes 104, and then the topology of the application management system 100 can take various forms, including but not limited to ring-type, star-type, tree-type and mesh-type configurations.

The application management system 100 according to the preferred embodiment comprises physical connections (e.g. ethernet cables) between the network components, in particular between the managed elements 104 and the application management server computer 101, thereby providing a communication connection 105. However the invention is not limited to physically connected networks but also applicable to wireless networks.

In the managed node 104, products 106, 107 and 108 are provided in the managed node 104, which represent programs running on the computer system of managed node 104.

The managed node 104 further hosts a TCP-Agent process 109. The object of the TCP-agent process 109 according to the preferred embodiment of the invention is, upon request from the TCP-server 102, to perform application log monitoring in the managed node 104. Thus, the TCP-agent process 109 also works as the management agent process for collecting management data which is stored in a management information predefined information data base by the products 106, 107, 108.

As can be further seen in FIG. 1, the web server program 103 residing in the management server computer 101 is connected via the internet 110 as a communication network to an interface unit 111, which hosts a web browser program 112 as well as a GUI (Graphic User Interface) 113. The GUI 113 is used for administration of the application management system 100. Via the GUI 113, the requested and thus determined application management data is displayed to a user.

The transmission of requests from the TCP-server 102 to the TCP-agent process 109 as well as the transmission of the required information from the TCP-agent 109 back to the TCP-server 102 is achieved by transmission of XML (Extensible Markup Language)-application management data, as illustrated in FIG. 1 by means of the broken double-arrow. In other words, the application management data transferred between the management server computer 101 and the managed element 104 is encoded according to the XML format and, in the transport layer, according to the TCP format.

The XML-based data transfer between the TCP-server 102 and the TCP-agent process 109 is performed as TCP (Transmission Control Protocol) or by using UDP (User Datagram Protocol) for the transport layer of the OSI-layer model. According to the use of the TCP, the success of the transmission may be controlled.

The exchange of application management data in the network proceeds as follows:

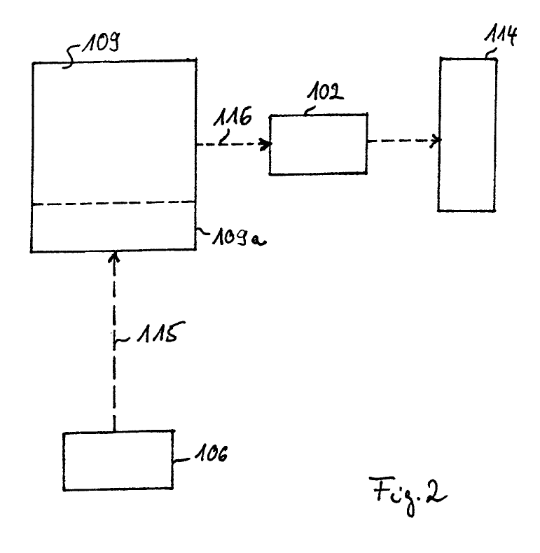

First, the products 106, 107, 108 managed by the TCP-agent process 109 have to define themselves to the TCP-agent process 109. The corresponding procedure is described with respect to FIG. 2.

In FIG. 2, the procedure of the products 106, 107, 108 to define themselves to the TCP-agent process 109 is illustrated for the example of product 106.

For the purpose of registration of the products, each product 106, 107, 108 sends XML-based data units 115 to the TCP-agent process 109, which comprises a XML-engine 109a for obtaining the corresponding information and initiating actions based on the specifications in the XML-based data units 115.

The XML-based data units 115 comprise the entire behaviour of products 106, 107, 108 as an XML-document, which represents a product definition of product 106 and which adheres to a template in the XML-based data units 115.

The behaviour describes the product in particular with regard to the following aspects:

Where is the product installed;

How to start that product;

How to stop that product;

How to query the status;

Where it stores the logfile;

What is the logfile pattern;

What actions to be executed when a fault occurs.

The TCP-agent process 109 provides the corresponding information to the TCP-server 102, which again maintains the data about all products 106, 107, 108 as well as about the corresponding TCP-agents process 109. The data about all products 106, 107, 108 and TCP-agent processes 109 are then included into a product list 114.

Then any kind of management applications may be performed by the management system 100 as described in the following:

As soon as a request message concerning the need of information about a product 106, 107, 108 monitored by a TCP-agent process 109 is sent from the web server 103 to the TCP-server 102, the TCP-server 102 sends a XML-based request message to the corresponding TCP-agent process 109.

According to this embodiment, the request message has the following structure:

<GetStatus>

<Machine>myhost.com</Machine>
<ApplicationName>ORB</Application>
<Command>

<Name>/usr/local/bin/obj_locator<Name>
<Args>
<Arg>-status</Arg>
<Args>

</Command>

</GetStatus>

The TCP-agent process 109 executes all actions required according to the request message, e.g. monitors activity of products 106, 107, 108, and reports the results obtained from execution of the required actions to the TCP-server 102 by means of XML-based data units 115.

Furthermore, a list of applications or scripts that should get invoked when a problem or a fault occurs in the managed system is defined and stored in a further XML file.

According to this embodiment, the list has the following general structure:

<Logfile>

<MatchCondition>

<Pattern>Apache webserver shutdown</Pattern>
<Severity>Major</Severity>
<Action>
<Command>
<Application>/opt/apache/bin/restart_apache
</Application>
</Command>
</Action>

<\MatchCondition>.

<\Logfile>.

The results received in the TCP-server 102 are sent via internet 110 to the web browser program 112 and the results obtained by the web browser 112 are presented to the user by the graphic user interface 113.

The management applications to be realized by the management system 100 are not limited to application log monitoring, but may also comprise e.g. lifecycle management or configuration management of the network components.

For a more detailed illustration, referring again to FIG. 1, the entire architecture of the application management system 100 will be described in the following.

A user is working on an interface unit 111. This interface unit comprises the graphical user interface (GUI) 113 and a web browser program 112. The user operates the web browser via the GUI 113 and sends a request message (e.g. a Get- or a Set-Request) via the internet 110 to the web server program 103 operated on the network management server computer 101.

The network management server computer 101 further comprises a TCP-server 102 in communication with the web server program 103. The above-mentioned request message is forwarded from the web server program 103 and from there to the TCP-Server 102 to the TCP-agent process 109 being part of the element to be managed 104, e.g. a client computer.

The transmission of the request message from the TCP-server 102 to the TCP-agent process 109 is at least partially XML-based (Extensible Markup Language).

The element to be managed 104 additionally comprises at least one product 106, 107, 108 to be managed (e.g. three products 106, 107, 108 in the embodiment are shown in FIG. 1).

The data requested by management system is passed to the TCP-agent through the TCP-server. TCP-client actually performs the desired action and sends the response back to TCP-server.

The response message is forwarded to the web server program 103 on the management server computer 101 and is transmitted from there via the internet 110 to the interface unit 111.

The user monitoring the system 100 via the graphical user interface 113 has therewith access to the requested information via the web browser.

What is claimed is:

1. An application management system, comprising
a management server computer;
at least one managed application being coupled to the server computer via a communication network; and
means for encoding and decoding application management data for transmission between the management server computer and the managed application, the means for encoding and decoding application management data being adapted to encode and decode application management data at least partially based on a markup language format.

2. The application management system according to claim 1, wherein the means for encoding and decoding application management data are adapted to encode and decode application management data at least partially based on an XML format.

3. The application management system according to claim 1, wherein the means for encoding and decoding application management data comprise a TCP encoding and decoding means.

4. The application management system according to claim 1, wherein the application management server computer further comprises a browser application program being communicatively coupled to the means for encoding and decoding application management data that is installed at the application management server computer in a way that a application management data request message is forwarded from the browser application program to the means for encoding and decoding application management data.

5. The application management system according to claim 1, wherein the managed application comprises an agent process being communicatively coupled to a management information data base, in which the application management data about at least one application of the managed application is stored.

6. The application management system according to claim 1, wherein the application management data comprises at least one type of the following data:
lifecycle management data,
configuration management data, and/or
application log management data.

7. The application management system according to claim 1, comprising a further browser application program being installed on an application management client computer, which is coupled to the management server computer via a communication network, the further browser application program being adapted to send application management data requests.

8. An application management server device, comprising a first means for encoding and decoding application management data for transmission to and from at least one managed application being coupled to the server device via a communication network, the first means for encoding and decoding application management data being adapted to encode and decode application management data at least partially based on a markup language format.

9. A managed application, comprising a second means for encoding and decoding application management data for transmission to and from a application management server device being coupled to the managed application via a communication network, the second means for encoding and decoding application management data being adapted to encode and decode application management data at least partially based on a markup language format.

10. A method for managing managed applications using an application management system comprising a management server computer, at least one managed application, wherein application management data is transmitted between the management server computer and the managed application, wherein the transmitted application management data is encoded at least partially based on a markup language format.

11. The method according to claim 10, wherein the application management data encoded at least partially based on an XML format is further encoded according to the TCP format.

12. The method according to claim 10, wherein a browser application program is provided in the management server computer for forwarding network a management data request from the browser application program to the means for encoding and decoding application management data.

13. The method according to claim 12, comprising the following steps:
encoding a application management data request message at least partially according to a markup language format;
encoding the application management data request message according to the TCP format;
transmitting the encoded application management data request message to the managed application;
decoding the encoded application management data request message according to the TCP format;
decoding the TCP-decoded application management data request message at least partially according to the markup language format;
determining the requested application management data requested in the application management data request message; and
reporting the determined requested application management data to the management server computer.

14. The method according to claim 13, comprising the following steps:
encoding an application management data response message at least partially according to the markup language format, the application management data response message including the determined requested application management data;
encoding the application management data response message according to the TCP format;
transmitting the encoded application management data response message to the management server computer;
decoding the encoded application management data response message according to the TCP format;
decoding the TCP-decoded application management data response message at least partially according to the markup language format.

15. The method according to claim 14, displaying the determined requested application management data using a graphic user interface.
